(19) United States
(12) Patent Application Publication
(10) Pub. No.: US 2010/0297933 A1
(43) Pub. Date: Nov. 25, 2010

(54) DATA PROVIDING DEVICE

(76) Inventor: Calvin T.Y. Sim, Singapore (SG)

Correspondence Address: JOHN BRUCKNER PC, P.O. BOX 17569, SUGAR LAND, TX, 77496-7569, US

(21) Appl. No.: 12/735,244

(22) PCT Filed: Oct. 13, 2008
(86) PCT No.: PCT/GB2008/003467

§ 371 Date: Aug. 6, 2010

(30) Foreign Application Priority Data
Oct. 18, 2007 (GB) 0720440.7

(51) Int. Cl. G06F 12/00; H04H 20/71

(52) U.S. Cl. 455/3.05; 711/115; 455/3.01

(57) ABSTRACT

A data providing device according to the present invention is connected to a host device. Once connected, the data providing device is capable of outputting data from a data source of the data providing device. Preferably, the data providing device is further capable of processing the data. After processing of the data has finished, a data interface of the data providing device is then operable to present the processed data to the host device so that it appears to the host device as though the processed data is the stored content of a removable storage device. By emulating a removable storage device in this way the data providing device of the present invention is able to successfully communicate dynamically output and processed data to the host device without the need for a user of the host device to install specific software interface drivers on the host device.

### TECHNICAL FIELD

This invention relates to a data providing device that is capable of emulating a removable data storage device. More particularly, embodiments of this invention relate to an apparatus for providing data and presenting that data to a host device as files and directories within a storage volume of a removable data storage device.

### BACKGROUND OF THE INVENTION

It is well known that inter-compatibility is often a problem between different devices that, in theory, should be able to operate as part of the same system. For example, a typical personal computer (PC) has the capability to operate with a wide range of peripheral devices, such as a web-camera, a Digital Audio Broadcast (DAB) radio receiver, or the like. However, in order for a peripheral device to be able to operate with a PC, both devices must share a common interface. For example, a Universal Serial Bus (USB) DAB receiver and a cooperating host PC must both support communication across a USB interface if the two devices are to understand each other. In addition to the physical plug and socket configurations present on both devices matching, it is also necessary that both devices are capable of communicating using the same communications protocol. This requirement is analogous to two people having to speak the same language before they are capable of understanding what the other is saying.

Software interface drivers are often required by a host device, such as a PC, to enable it to understand information output from a peripheral device, such as a DAB receiver. Without such software interface drivers a desired output from the peripheral device, such as an audio broadcast, cannot be delivered to a human user of the host device. Software interface drivers enable the host device to interact with the peripheral device by defining a specific set of instructions that may be exchanged between both devices so that they are able to understand each other. Frequently, rather than defining a whole new protocol for the two devices to understand each other, specific instructions are defined that use a standard communication protocol already in existence. For example, the Small Computer System Interface (SCSI) protocol is often used by devices communicating with each other across a USB interface.

Without the necessary software interface drivers installed on the host device, the host device is unable to understand the messages sent by the peripheral device and, therefore, is incapable of delivering the output received from the peripheral device to the user. This need for a specific software interface driver is often a problem when the user does not have sufficient access privileges to install new software on the host device, or the host device does not contain suitable means for receiving the software driver, for example a floppy disk or CD drive.

In contrast to the peripheral devices discussed above, there are some peripheral devices which do not usually require a user to install specific software interface drivers on a host device before they are able to communicate with the host device. A USB Mass Storage Device (MSD) is one example of a peripheral or removable device that does not usually require a user to install a specific software interface driver when used in conjunction with a PC. This is because many PCs have physical interface sockets capable of connecting with a USB MSD and are pre-loaded with intrinsic software interface drivers that are capable of communicating with a USB MSD.

Another type of removable storage device is a memory card, such as, Secure Digital (SD), Compact Flash (CF), Multi-Media Card (MMC), Memory Stick (MS), or the like. Many host devices including PCs, cameras and portable telephones have physical and software interfaces that enable them to connect to and communicate with such cards without the need for a user to install a specific software interface driver.

A memory card or MSD is a removable computer memory storage device that may be plugged into a host device via a standard connector interface. A common incarnation of such a device is a USB Flash Drive.

In operation, a MSD is connected to a host device so that a user may transfer data from the host device to the memory of the MSD. Once data transfer is complete the user may disconnect the MSD from the host device. Therefore, the MSD may be used as both a data storage means and a means for transporting data between host devices. An MSD typically stores data within files in a directory structure, as is well known in the art. The file and directory structure is presented to the host device for selection of a file by the host device for reading therefrom.

Therefore, for some classes of device i.e. removable storage devices, the problems of inter-operability have already been solved; the host devices are intrinsically capable of communicating therewith. However, for other device types, and particularly device types that act as data sources that dynamically provide data, such as devices that reproduce broadcast data such as radio receivers or TV receivers, or devices that generate data such as cameras, the problems have not yet been fully addressed, and it is typical to still require additional software device drivers to be installed on the host device.

### SUMMARY OF THE INVENTION

In order to address the above problems, an embodiment of the present invention provides a data providing device which does not require a user of a cooperating host device to install a specific software interface driver on the host device to enable it to communicate with the data providing device.

More specifically, a data providing device of a preferred embodiment of the present invention is capable of emulating a removable storage device and presenting dynamically output data from the data providing device to a cooperating host device in the same format as the contents of a removable storage device. Operating in this manner eliminates the need for a user to install specific software interface drivers on the host device for it to be capable of communicating with the data providing device. Instead, the data providing device is able to communicate with the host device using an intrinsic software interface driver already installed on the host device.

In view of the above, the present invention provides a data providing device for providing data to a host device, the device comprising a data source which buffers dynamically changing data and outputs the data for provision to the host device, and a data interface which presents the data for provision to the host device as static contents within a removable storage device that is recognised by and communicates with the host device through at least one mass storage device driver that exists on the host device.

It is a further aspect of the present invention to provide a method for providing data from a data providing device to a host device, the method comprising the following steps:
a. buffering dynamically changing data within a data source of the data providing device,
b. presenting the data as static content within a removable storage device, to the host device, by a data interface of the data providing device wherein, the removable storage device is of a type that is recognised by and communicates with the host device through at least one mass storage device driver that is installed on the host device, and
c. outputting the data for provision to the host device from the data source.

A primary advantage of the present invention is that a user of a host device does not have to install specific software interface drivers on the host device in order for it to be able to receive and understand information from the present invention.

Moreover, the dynamic output of data from the data source may be, for example, the reproduction of data which has been broadcast, for example, a TV or radio signal, or may be generated data, for example from a peripheral such as a camera or microphone. Moreover, preferably the dynamic output of data is substantially continuous, at least in any one operating session. In this way embodiments of the invention are capable of presenting the output of such data sources as the contents of a removable storage device, and hence additional driver software for devices representing such data sources is not required to be installed on the host device. By operating in this way the data providing device of the present invention is able to provide a functionality to the host device which is in addition to the device's functionality of being able to emulate a MSD. As mentioned above, this additional functionality can be the functionality of a radio receiver or a camera, for example.

Preferably, the data source is capable of being instructed by the host device to select which dynamically changing data it buffers and outputs, from a plurality of sets of such data. It is therefore an advantage of this embodiment that the host device is able to control the functionality of the data providing device. For example, if the data source outputs data generated from a peripheral such as a camera then, according to this embodiment, the host device is able to chose which photographic images are output from the data source and which are not.

Preferably, the data interface of an embodiment of the present invention arranges the data for provision to the host device into files. Additionally, it is preferable that the files are further arranged into directories. This is particularly advantageous, as host devices are typically able to navigate data in such a manner. Additionally, it is preferable that each file is mapped to a unique logical memory sector of the data providing device.

Preferably, the data source of an embodiment of the present invention is a receiver for wirelessly receiving data broadcast from an external device. By way of example, the receiver may be any of a Digital Audio Broadcasting (DAB) receiver, Digital Multimedia Broadcasting (DMB) receiver, Terrestrial Digital Video Broadcasting (DVB-T) receiver, or an analogue TV or radio receiver. Furthermore, it is preferable that the receiver is triggered to receive data by commands received from the host device.

Preferably, the receiver is capable of receiving one or more broadcast signals from one or more external devices, the or each signal containing one or more broadcast services, and wherein the dynamically changing data includes at least one broadcast service specified by a command received from the host device. It is an advantage of this embodiment that the data providing device can receive control commands from the host device which instruct the receiver of the data providing device to tune to, and retrieve data relating to, a broadcast service specified by the host device. Therefore, a user of the host device can control the functionality of the receiver of the data providing device using the host device.

Preferably, a command received by the data providing device from the host device specifies the at least one broadcast service by comprising a representation of the at least one broadcast service. It is additionally preferable that the representation comprises a representation of a broadcast frequency of the broadcast signal containing the at least one broadcast service and, a representation of the at least one broadcast service. In one embodiment, the command received from the host device is a request for the contents of a specific file stored on the data providing device and, the filename of the requested file comprises the representation of the desired service. In another embodiment, the command received from the host device is a string written by the host device to a specific memory sector of the data providing device and, the string comprises the representation of the desired service.

Preferably, the receiver is capable of being instructed by the host device to receive a different broadcast service by receiving a command from the host device comprising a representation of the different broadcast service. It is an advantage of this embodiment that the receiver of the data providing device can be controlled by the host device so that the broadcast service received by the receiver can be changed during operation. According to this feature, a user of the host device is able to use the host device to select different broadcast services to be received by the data providing device and provided to the host device.

Preferably, the data interface is capable of enabling:
i. delivery of data relating to commands specifying broadcast services, from the host device to the receiver;
ii. delivery of data relating to broadcast signals and broadcast services available to be received by the receiver, from the receiver to the host device; and,
iii. delivery of data relating to broadcast services specified by commands received from the host device, from the receiver to the host device.

It is an advantage of this embodiment that data may be exchanged between the host device and the data providing device to facilitate control of the data providing device by the host device. In particular, this enables provision of broadcast data requested by the host device from the data providing device to the host device. It is additionally preferable that delivery of data comprises writing the data to the logical memory sectors of the data providing device and subsequently reading the data from the logical memory sectors of the data providing device. Accordingly, the host device can write commands to logical memory sectors of the data providing device so that the data providing device can then read and carry-out those commands. Additionally, the data providing device may write data, such as broadcast service data, to logical memory sectors of the data providing device so that the service data can be read by the host device as static content of a removable storage volume.

Preferably, an embodiment of the present invention is capable of processing the data before the data is presented to the host device. For example, where the data source is a receiver, then the data is demodulated prior to presentation.

Preferably, an embodiment of the present invention is capable of storing the data for a finite period after it has presented that data to the host device, in order to facilitate a rewind capability.

Preferably, an embodiment of the present invention is capable of communicating with a host device via a standard Universal Serial Bus (USB) interface, a Serial Peripheral Interface (SPI) bus, a Secure Data Memory Interface (SD) bus, Integrated Drive Electronics (IDE) bus, or Small Computer System Interface (SCSI) bus.

Preferably, an embodiment of the present invention is capable of presenting the data to the host device as the contents of a USB Mass Storage Device (MSD), a Secure Digital (SD) memory card, a Multi-Media Card (MMC), Compact Flash (CF) memory card, or a SCSI hard disk.

Preferably, an embodiment of the present invention is capable of interfacing with any or all of a PC, a car radio, a miniature Hi-Fi, or a portable telephone.

### BRIEF DESCRIPTION OF THE DRAWINGS

An overview of the operation of the invention, together with a description of a number of embodiments thereof, presented by way of example only, will now be made with reference to the accompanying drawings, wherein like reference numerals refer to like parts, and wherein:—

FIG. 1 is a perspective view of a typical system within which a preferred embodiment of the present invention is intended to operate;

FIG. 2 is a schematic view of a typical system within which a preferred embodiment of the present invention is intended to operate;

FIG. 3 is a schematic view of a host device with which a preferred embodiment of the present invention is intended to operate;

FIG. 4 is a schematic view of a preferred embodiment of the present invention;

FIG. 5 is a schematic view of a radio tuner and demodulator unit according to the preferred embodiment of the present invention depicted in FIG. 4;

FIG. 6 is a ladder diagram representing communication between the host device and a preferred embodiment of the present invention when in operation;

FIG. 7 is a flow diagram representing the operation of the preferred embodiment of the present invention;

FIG. 8 is a schematic view of one example file structure as presented to a host device by a preferred embodiment of the present invention;

FIG. 9 is a schematic view of another example file structure as presented to a host device by a preferred embodiment of the present invention; and

FIG. 10 is a schematic view of an alternative embodiment of the present invention.

### OVERVIEW OF THE OPERATION OF THE INVENTION

Before proceeding to describe a particular embodiment of the invention, a brief overview of the operation of embodiments of the invention will first be undertaken.

More particularly, a data providing device according to an embodiment of the present invention is connected to a host device. Once connected, the data providing device is capable of outputting data from a data source of the data providing device. Preferably, the data providing device is further capable of processing the data, for example demodulating it in order to extract specific audio or video information. After processing of the data has finished, a data interface of the data providing device is then operable to present the processed data to the host device so that it appears to the host device as though the processed data is the stored content of a removable storage device, such as a USB MSD.

By emulating a removable storage device in this way the data providing device of the present invention is able to successfully communicate dynamically output and processed data to the host device using an intrinsic software interface driver already present on the host device. Therefore, the data providing device is able to operate without the need for a user of the host device to install specific software interface drivers on the host device.

The data providing device of the present invention is capable of operating in response to commands received from the host device. In particular, the host device is able to control the various functionalities of the data providing device by reading data from, or writing data to, logical memory sectors of the data providing device.

### DESCRIPTION OF THE EMBODIMENTS

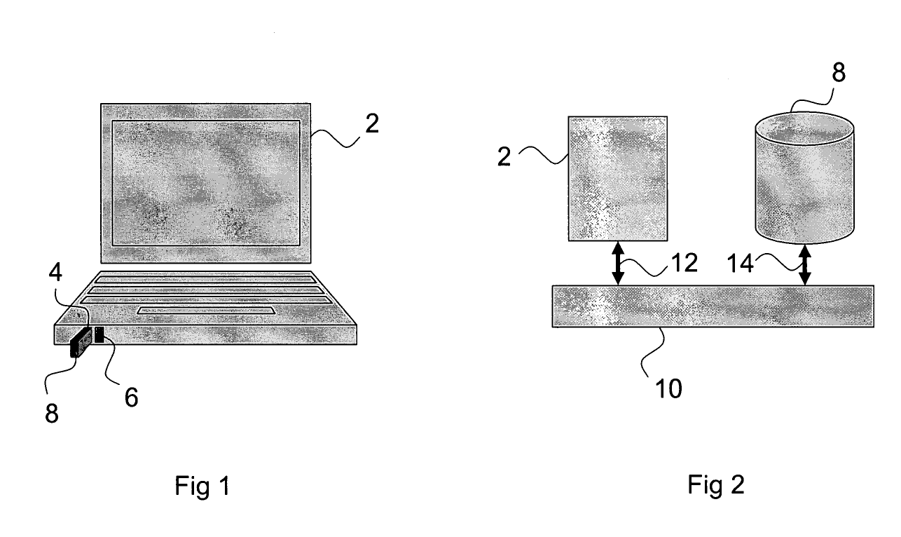

A preferred embodiment of the invention will now be described in detail. A typical system environment in which the invention is intended to operate is depicted in FIG. 1. A personal computer (PC) 2 contains two USB input sockets 4 and 6. A data providing device 8 according to an embodiment of the present invention is connected to the USB socket 4 of PC 2 so that data can be exchanged across the USB interface. In operation, airborne data signals (not shown) are broadcast from an external device (not shown) and received by the data providing device 8. The data providing device 8 is then operable to process the received data and deliver it to the PC 2 as though it is the content of a USB MSD. A detailed description of this process is provided below.

FIG. 2 shows a schematic representation of the interface between the PC 2 and the data providing device 8. Both PC 2 and data providing device 8 connect to a physical USB interface 10 so that electrical messages can be exchanged between the PC 2 and the data providing device 8 via connection lines 12 and 14. In general, control commands are sent from the PC 2, across the USB interface 10, to the data providing device 8, and data contents are returned via the same route from the data providing device 8 to the PC 2.

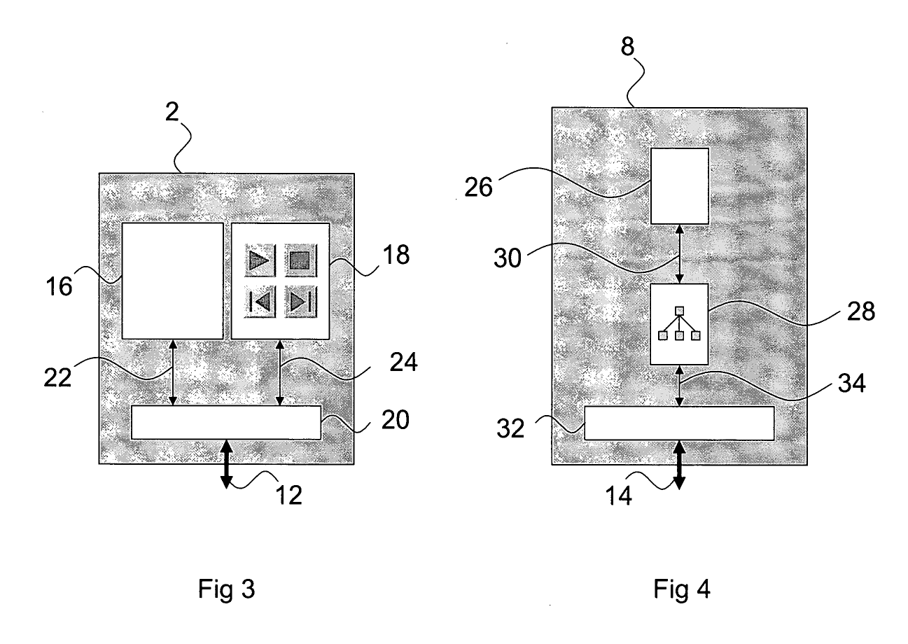

FIG. 3 illustrates the PC 2 of FIG. 2 in greater detail. From FIG. 3 it can be seen that the PC 2 further comprises a directory and file manager 16 and a media player 18 that are connected in parallel to an intrinsic USB driver 20 via connection lines 22 and 24, respectively. Finally, the intrinsic USB driver 20 is also connected to the connection line 12 which in turn is connected to the USB interface 10, as shown more particularly in FIG. 2. As before, the connection lines 22 and 24 facilitate the transfer of control commands from the PC 2 to the data providing device 8, and data contents from the data providing device 8 to the PC 2.

FIG. 4 illustrates the data providing device of FIG. 2 in greater detail. From FIG. 4 it can be seen that the data providing device 8 further comprises a radio tuner and demodulator unit 26 and a MSD emulator 28 that are connected together via a connection line 30. The MSD emulator 28 is also connected to a USB Bulk Transfer Mode Handler 32 via a connection line 34. Finally, the USB Bulk Transfer Handler 32 is also connected to the connection line 14 which in turn is connected to the USB interface 10, as shown more particularly in FIG. 2. As before, the connection lines 30 and 34 facilitate the transfer of data contents from the data providing device 8 to the PC 2, and control commands from the PC 2 to the data providing device 8.

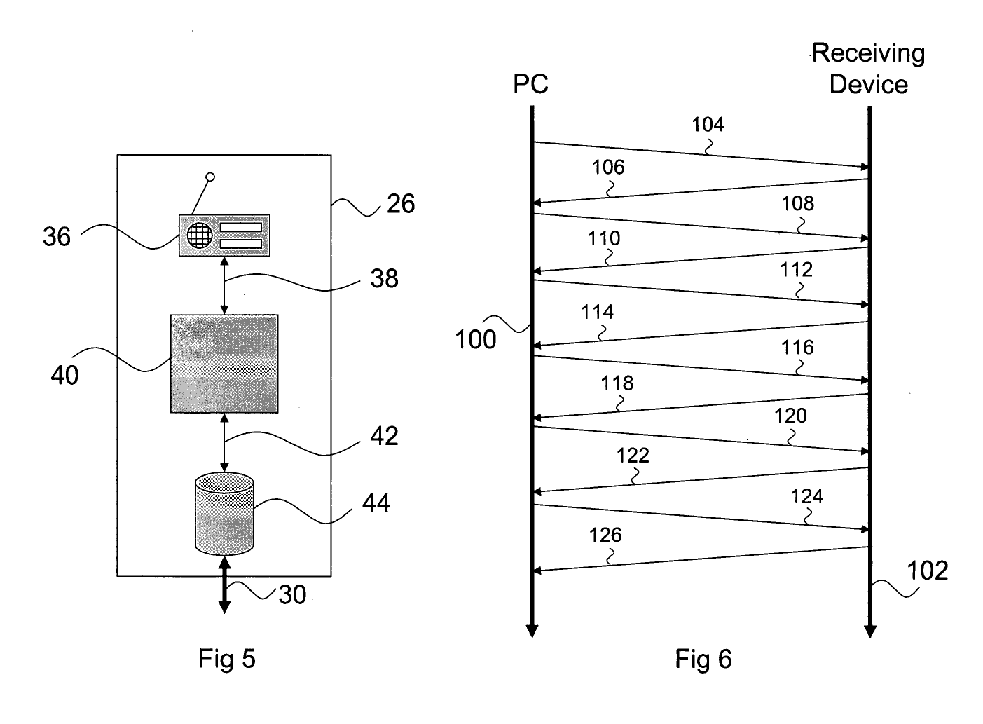

FIG. 5 illustrates the radio tuner and demodulator unit 26 of the data providing device 8 of FIG. 4 in greater detail. From FIG. 5 it can be seen that the radio tuner and demodulator unit 26 comprises a radio tuner 36 connected via a connection line 38 to a demodulator 40. The demodulator 40 is connected via a connection line 42 to a buffer 44, which in turn is also connected to the connection line 30.

The radio tuner 36 is capable of receiving data broadcast at particular frequencies, by an external device (not shown). Once received, the data is sent from the radio tuner 36 to the demodulator 40 so that service content can be extracted by demodulation. For example, received data might be demodulated so that relevant audio or video information is extracted. The extracted content is then stored in the buffer 44 where it is accessible to the MSD emulator 28.

In operation, the data providing device 8 presents service information representing available broadcast services to the PC 2, in a manner described in more detail later. The user of the PC 2 selects a service using the PC 2 and the PC 2 then instructs the data providing device 8 to tune to the service so as to extract service content therefrom. More particularly, once broadcast data is received at the frequency for the service, service content is extracted at the demodulator 40 and stored in the buffer 44. The MSD emulator 28 then transfers the service content from the buffer 44 to a specific memory sector of the device 8 that uniquely corresponds to the type of service content and the frequency at which it was received. For example, audio content extracted from a broadcast received at 96.3 MHz would be stored in a unique memory sector of the data providing device 8 that corresponded to the content type ‘audio’, and the frequency ‘96.3 MHz’. Furthermore, the MSD emulator 28 stores the transferred extracted content into a file located at the unique memory sector and having a file name corresponding to the content type. For example, an ‘.mp3’ file name extension may be used for a file containing content encoded according to the MPEG 1 Layer III standard. In the preferred embodiment, the filename of the file provides a representation of the broadcast service contained within the file. In particular, the representation comprises a representation of a centre frequency of the broadcast signal containing the service and a representation of the service. According to the MSD emulation performed by the present invention, the file allocation table of the data providing device 8 points to the same blocks of physical memory on the device despite the numbers of the memory sector clusters.

Organisation of service content within the memory sectors of the data providing device 8 is a key operation of the MSD emulator 28. Essentially, the MSD emulator implements an appropriate organised structure that mimics the file system of a typical MSD. In the preferred embodiment, the MSD emulator 28 arranges a number of directories that each branch from a single root directory. Each of these branching directories, for example, represents a different frequency that the radio tuner 36 can tune to. Then, within each of these directories are the files in which the MSD emulator 28 stores extracted service content. As is well known, within the DAB and DVB broadcast systems, several services can be multiplexed onto a single frequency channel. Therefore, navigating between directories provides a means to control tuning of the radio to different frequencies. Also, selecting particular files within a directory provides a means to selecting between different services available at a single frequency, for example audio, video or data services.

Typically, within the context of digital audio broadcasting (DAB), a group of multiplexed services are transmitted as a single signal (also known as a ‘DAB ensemble’). Also, within a typical operating environment for the present invention multiple signals (or DAB ensembles) are available for receiving by the data source of the providing device 8 during operation. Typically, each available signal is broadcast from the same source although it is possible that different signals are broadcast from different sources. It is know that individual broadcast signals are organised by their single frequency channel (also known as their centre frequency). The frequency band specified by a given centre frequency contains the group of multiplexed services. According to the present invention, this information is organised as files within a directory tree. More specifically, sub-directories branching from a root directory indicate the available signals (referenced by their centre frequency). Within each sub-directory the files stored represent the services which make up the signal represented by the sub-directory. Each file has a filename which provides a representation of the service it contains and each file represents a different available service of the signal.

When the PC 2 issues a control command to the data providing device 8 by selecting a particular file for playback, the data providing device 8 first needs to determine whether the broadcast service corresponding to the selected file is contained within the broadcast signal currently demodulating via the radio tuner and demodulator unit 26. In other words, the data providing device 8 must determine if the service selected by the PC 2 is available from the centre frequency to which the radio tuner 36 is currently tuned. If it is not, the data providing device 8 must first determine which centre frequency provides the requested service and then re-tune the radio tuner 36 to that centre frequency. In this way, the operation of the PC 2 in selecting a particular file from the device 8 for playback controls the functionality of the data providing device 8. In particular, this includes, tuning of the radio tuner 36 to a different centre frequency; collecting service information relating to a broadcast signal being demodulated by demodulator 40; selecting a particular service from a broadcast signal being demodulated by demodulator 40; and, retrieving data relating to a selected service.

FIG. 6 illustrates a typical communication sequence that might be initiated between the data providing device 8 and the PC 2 when the two devices are connected together as depicted in FIG. 1 or FIG. 2, and then operated. Two timelines 100 and 102 represent a passage of time which begins at the labelled end and finishes at the arrowhead end. At various points along the timelines 100 and 102, arrows 104 to 126 represent the exchange of data either from the PC 2 to the data providing device 8 or vice versa, according to the direction of the arrow.

Upon physical connection between the data providing device 8 and the PC 2, the PC 2 automatically sends a message in accordance with the USB protocol, represented by arrow 104 to request that the data providing device identifies itself. The data providing device 8 responds with a message that specifies a MSD type and identification details, as represented by arrow 106. The PC 2, on receiving the type and identification details, interrogates the storage volume of the data providing device 8 from a first logical memory sector, as represented by arrow 108. The data providing device 8 responds by returning a Master Boot Record (MBR), as represented by arrow 110.

As represented by arrow 112, the PC 2 uses the MBR to identify what active partitions are present on the data providing device 8. The PC 2 then requests the Partition Boot Record (PBR) of each partition from the data providing device 8, according to the memory sector number of each partition. Arrow 114 represents each PBR being returned to PC 2 by the data providing device 8 as requested.

As represented by arrow 116, the PC 2 uses each PBR to identify the file system used in each partition. The PC 2 then requests the contents of the top level (also known as the root) directory by reading relevant memory sectors of the data providing device 8 according to the PBR. Arrow 118 represents the data providing device returning the contents of the root directory as requested.

As discussed above with reference to FIG. 4, the root directory of the data providing device 8 contains a number of branching directories. In this embodiment, the exact number of directories present depends on how many frequencies the radio tuner and demodulator unit 26 can receive service information from. Furthermore, preferably the name of each directory corresponds with the frequency to which the radio was tuned when the service information contained within the directory was received. In other embodiments, a different arrangement of files and directories may be used, for example, services may be arranged by service content type, rather than by group frequency.

Once initialisation of data providing device 8, as represented by arrows 104 to 118, has been completed, a user of the PC 2 may select content of the data providing device 8 to be presented to the PC 2. Using the media player 18 of the PC 2 the user can interrogate the contents of each directory branching from the root directory of the data providing device to determine which services are available for each frequency. For example, within a single frequency, depending upon the contents of that particular broadcast, both audio and video services may be available and represented by appropriately named files. Therefore, as represented by arrow 120, the user requests the contents of a particular directory on the data providing device 8. Arrow 122 represents the data providing device responding with the names of the files contained within the chosen directory. The names of the returned files correspond to each particular service available; the file extensions correspond to the type of service, for example an audio file, such as ‘.mp3’, will contain an audio service. Arrow 124 represents the user selecting a particular file in the chosen directory of the data providing device 8 using the media player 18. This operation sends control commands from the PC 2 to the data providing device 8 that request the contents of the memory sectors of the data providing device 8 that correspond with the chosen file. As the requested memory sectors are uniquely associated with the chosen service, the data providing device 8, upon receiving the arrow 124 request, fills the chosen memory sector from the buffer 44 with the most recent information retrieved from the associated service. Should insufficient data be available, the USB transport of the PC 2 that is responsible for communication with the data providing device 8 is stalled while the requested information can be received and demodulated by the data providing device 8. In effect, the user's act of selecting a file for playback from the data providing device 8 using the media player 18 triggers the data providing device 8 to play corresponding data from the buffer 44. If no such data exists in the buffer 44 then, instead, the user's act triggers the data providing device 8 to dynamically receive the requested data from a broadcast of an external device. Finally, arrow 126 represents the data providing device 8 returning the requested service information to the media player 18 of the PC 2 for playing.

Using the buffer 44, the data-providing device 8 is capable of storing and presenting data to the media player 18 at a rate that is at least equal to the data-rate of the type of media file being read by the PC 2, such as, for example an .mp3 file type. Accordingly, continuous playback is achieved because the average throughput of the data providing device 8 to the PC 2 is no less than the bit-rate of the multimedia file. Additionally, a continuous supply of valid data is streamed to the PC 2 by the data providing device 8. In order for the MSD emulator 28 of the data-providing device 8 to emulate files correctly, the file size of the emulating file must be greater than the size of the buffer 44. In the preferred embodiment, the file size is set to be 4 GB large. Depending on the size of the buffer 44 the present invention may optionally provide the capability to rewind by presenting demodulated information to the PC 2 that was stored within the buffer 44 some time ago.

According to the above described operation of the preferred embodiment, if the PC 2 requests a file for playback which corresponds to a service that is available from the frequency to which the radio tuner 36 is currently tuned then, the data providing device 8 can fill the appropriate memory sector with the service data without retuning the radio tuner 36. Alternatively, if the PC 2 requests a service which is not available from the currently tuned centre frequency then, the data providing device 8 must first re-tune the radio tuner 36 to the appropriate centre frequency for the service represented by the filename of the file requested for playback by the PC 2. Once the radio tuner is re-tuned, the requested service data is received, demodulated, buffered and used to fill the appropriate memory sector of the data providing device 8. In either case, further data retrieval from that file by the PC 2 facilitates streaming of more buffered data belonging to the selected service as demodulated in real-time.

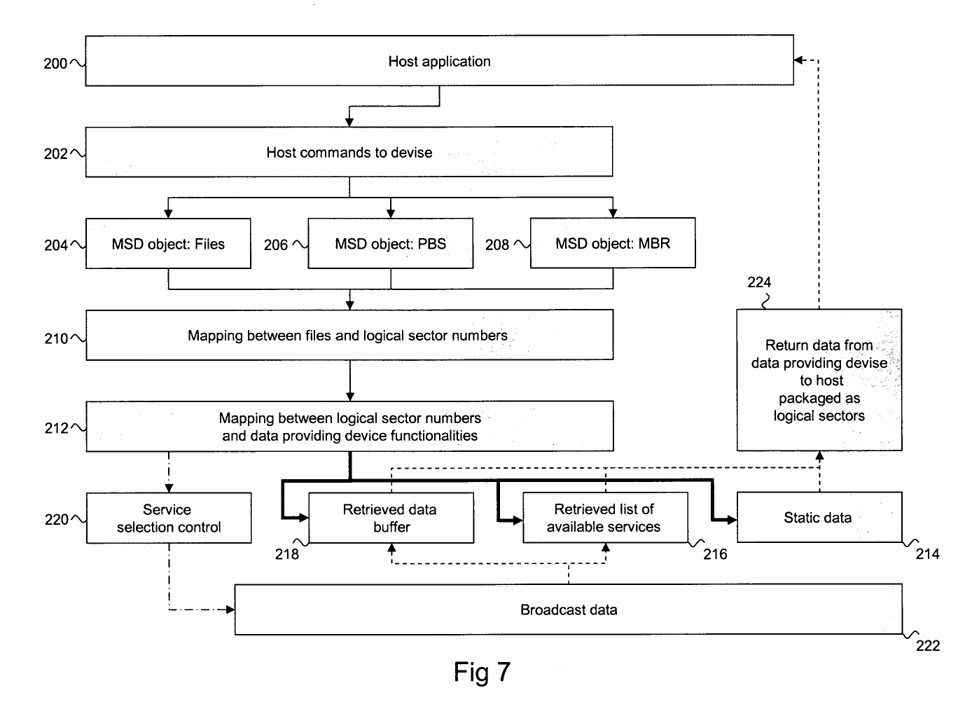

The operation of the preferred embodiment of the present invention will now be further described with reference to the flow diagram of FIG. 7.

The flow diagram of FIG. 7 begins at step 200 wherein a host application running on a host device (e.g. the directory and file manager 16, or the media player 18, running on PC 2) is operated by a user of the host to interface with the device 8. As described above with reference to FIG. 6, the host may communicate with the device 8 and request a MBR, a PBS, the contents of the root directory or a file for playback. Once the user has instructed the host application to interface with the device 8, at step 202 the PC 2 converts the user request into a corresponding instruction for sending to the device 8. According to steps 204 to 208, the PC 2 may request either a file or root directory contents (step 204), a PBS (step 206) or a MBR (step 208). What precisely is requested in a given situation will depend on the user's instruction and the state of initialisation between the PC 2 and the device 8.

Once the PC 2 has issued an instruction to the device 8 at either step 204, 206 or 208, processing flows to step 210. At step 210, the device 8 determines the logical memory sector of the device 8 which corresponds to the MSD object (a file/root directory content, a PBS, a MBR) requested by the instruction. Processing then flows to step 212. At step 212, the device maps the logical memory sector corresponding to the instruction into an appropriate device function. In other words, at step 212 a request to interrogate a memory sector is converted into a device function, wherein the precise function depends on the particular memory sector. Once the device 8 has determined which operation it must now perform processing at step 212 is complete. After step 212, the processing path will depend on the instruction received from the PC 2 (or in other words which device functionality that instruction corresponds with).

If the instruction is a request for the PBS or an MBR, processing will flow from step 212 to step 214 wherein the device 8 will obtain the relevant data from the appropriate memory sector. Alternatively, if the instruction is a request for the contents of the root directory then processing flows to step 216. As mentioned above with reference to FIG. 5, each sub-directory branching from the root directory represents a different available broadcast signal therefore, when the PC 2 requests the contents of the root directory the device 8 must determine which broadcast signals (including their broadcast services) are available to be received. According to the preferred embodiment, at step 216, the device 8 determines this by scanning its entire frequency range of operation using the radio-tuner 36 and the demodulator 40. Alternatively, if at step 212 the logical memory sector requested corresponds to a specific file, processing flows to step 218. At step 218, the device 8 obtains data from the requested memory sector relating to the broadcast service corresponding to the requested file. This operation can only be performed if the broadcast service relating to the requested file can be obtained from the centre frequency to which the radio tuner 36 of the device 8 is currently tuned. If the broadcast service can only be obtained from a different centre frequency than the one currently tuned to, processing flows from 212 to 220 rather than to 218. At step 220, the device 8 determines the new centre frequency that the radio tuner 36 must be tuned to in order to receive the broadcast service corresponding to the requested file. Once the new centre frequency has been determined at step 220 processing flows to step 222 wherein the device 8 re-tunes the radio tuner 36 to the new frequency to receive the requested broadcast data. Once the broadcast data has been received the device 8 demodulates the data and then performs two operations. Firstly, it fills the buffer 44 with data relating to the specifically requested broadcast service so that the data may be obtained for provision to the host device at step 218 (as discussed above). Secondly, it updates the list of available broadcast services which is retrieved during operation at step 216 (as discussed above). There are numerous reasons why this list may require updating, such as, for example, the geographic location of the device has changed.

Processing from each of steps 214, 216 and 218 flows to step 224, wherein the data obtained at either step 214, 216 or 218 is packaged as the data content of logical memory sectors of the data providing device by the MSD emulator 28 for provision to the PC 2. It is noted that the style of the arrows of FIG. 7 indicates the type of instruction transferred at the stage in the operational flow represented by each arrow. More specifically, a continuous arrow indicates a command from the host (PC 2) to the device; a bold continuous arrow indicates a command issued within the device 8 to retrieve data from a memory sector of the device 8; a dashed arrow indicates data returning to the host (PC 2); finally, a dash-and-dot arrow indicates a command to control the operation of the radio tuner and demodulator unit 26.

It should be noted that different file systems to those mentioned above may be implemented without departing from the present inventive concept. For example, directories may be organised according to the different types of service available and files within each directory could be organised according to which frequencies provide services of that type. Additionally, the file system chosen will also be dictated, in part, by the type of removable storage device that the data providing device of the present invention emulates.

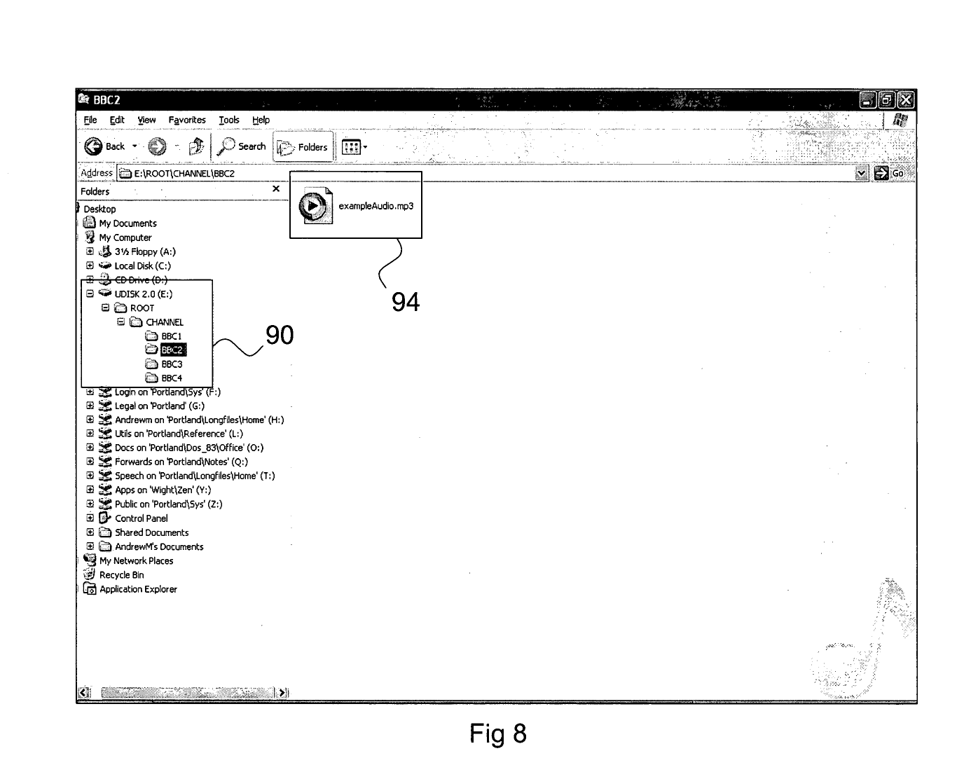

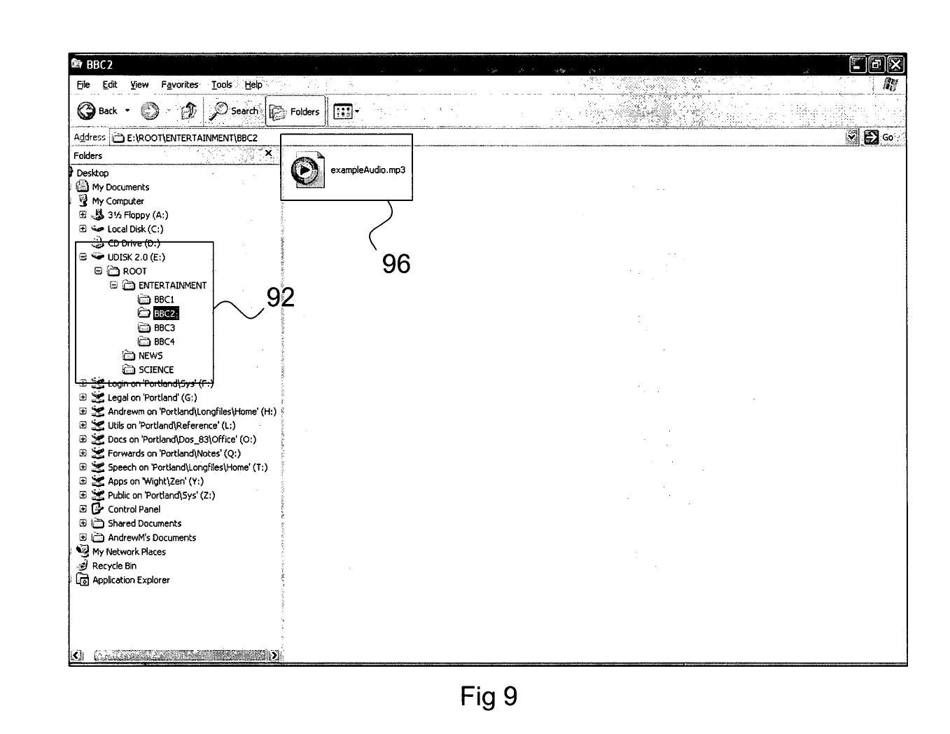

FIGS. 8 and 9 provide example file structures that may be presented by the data providing device 8 to the PC 2. In FIGS. 8 and 9, boxes 90 and 92 show the file structure implemented in either example, in a directory tree formation. Boxes 94 and 96 show the contents of one of the directories within the file structures of boxes 90 and 92, respectively. In both cases, the example directory contains the same, single audio file ‘exampleAudio.mp3’. In FIG. 8, the box 90 shows that the directories are arranged according to which channels are available, for example ‘BBC1’, ‘BBC2’, etc. Then, each directory contains files containing service information, for example ‘exampleAudio.mp3’, received from the channel corresponding to the directory name. In FIG. 9, the box 90 shows an alternative file structure in which directories are arranged according to the type of service available, for example ‘ENTERTAINMENT’, ‘NEWS’ or ‘SCIENCE’. Then, each directory within each service type contains further directories arranged according to the channels that provide that particular service type, for example ‘BBC1’, ‘BBC2’, etc. Finally, these channel directories contain service information, for example ‘exampleAudio.mp3’, that corresponds to the particular service type and channel at that position in the file structure.

In an alternative file structure of the present invention only three files are present in the root directory, with no sub-directories. These three files each occupy a distinct and non-overlapping sector in the MSD representation of the data providing device 8. The first file is written to by the PC 2 when a request is made for a particular broadcast service. More specifically, the PC 2 requests a specific broadcast service by writing a string to the first file which uniquely identifies the specific broadcast service. In the present embodiment, the string comprises a representation of a centre frequency of the broadcast signal containing the service and a representation of the service. The second file can be read by the PC 2 to determine a list of available broadcast services in the signal currently demodulating from the broadcast network (i.e. the signal having a centre frequency equal to the frequency that the radio tuner 36 is currently tuned to). The third file is read by the PC 2 to retrieve the buffered data corresponding to the broadcast service being demodulated in real-time. During operation, the third file contains data relating to the broadcast service identified by the string written to the first file. As was the case in the preferred file structure, in the alternative file structure there exists an unambiguous mapping between logical memory sector numbers and functions of the data providing device.

An important distinction between the operation of the data providing device with the preferred file structure when compared with the alternative file structure is that, in the preferred file structure the PC 2 requests to read files from the data providing device 8.

Moreover, the PC 2 does not write data to the logical memory sectors of the data providing device 8. Alternatively, operation of the data providing device 8 with the alternative file structure requires that the PC 2 writes data strings to the logical memory sectors of the data providing device, in addition to reading data from the device 8. In particular, the PC 2 sends commands to the data providing device 8 by writing to a pre-defined range of sectors defined within the file structure or FAT framework of the data providing device 8.

It is important to note that whatever the file structure, each different functionality of the data providing device must be uniquely identified by either the sector number or the actual data string written to that sector by the PC 2.

A USB data providing device has been used above as a vehicle for explaining the preferred embodiment of the invention. However, the invention is not so limited and other embodiments do not necessitate the use of the USB interface. Therefore, it is possible to create alternative embodiments of the present invention by modifying the data providing device to create an SD card receiver, or a MMC receiver. The only difference between the preferred embodiment and these alternative embodiments is the interface the receiver uses to communicate with the PC, and the physical connector used to connect with the PC. In fact, an embodiment of the present invention may be configured to emulate the structure of any removable storage volume. The key principle is that the file structure and interface used should correspond so that the data providing device of the present invention is able to connect to the PC and emulate the removable storage volume convincingly.

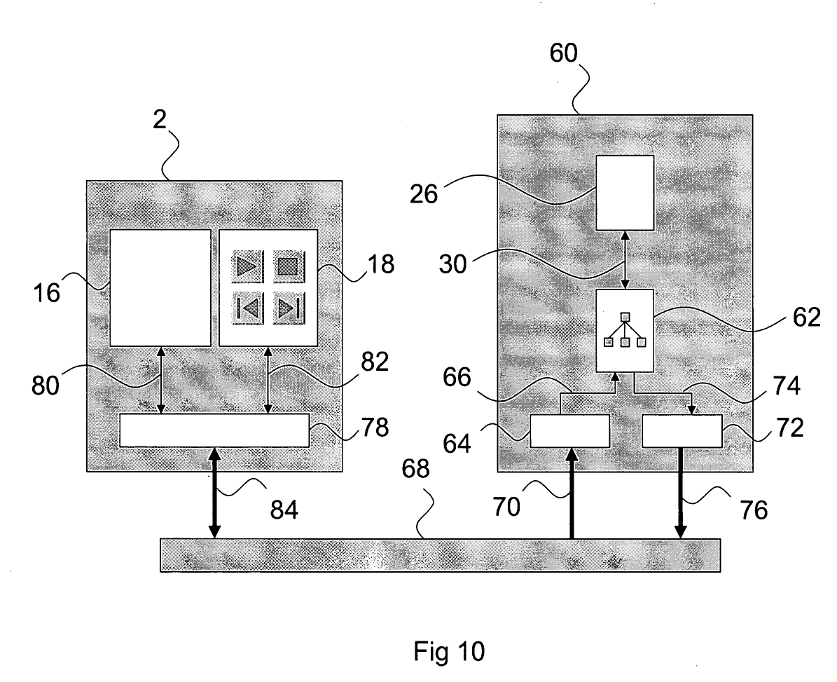

Accordingly, FIG. 10 depicts an alternative embodiment of the present invention in which a data providing device 60 emulates a SD or MMC memory card, rather than a USB MSD. It should be noted that like reference numerals in FIG. 10 correspond to like components featured in other Figures. In the data providing device 60 the radio tuner 26 communicates with a storage volume emulator 62 via the connection line 30. The storage volume emulator 62 receives control commands from a page mapping element 64 via a connection line 66. In turn, the page mapping element 64 is connected to a Serial Peripheral Interface (SPI) physical medium 68 via a connection line 70 so that it can receive control commands across the SPI physical medium 68. The storage volume emulator 62 is also connected to a processing unit 72 via a connection line 74 so that it can send data contents to the processing unit 72. In turn, the processing unit 72 is connected to the SPI physical medium 68 via a connection line 76 so that it can send data content across the SPI physical medium 68. In order that the directory and file manager 16 and the media player 18 of PC 2 are able to communicate with the data providing device 60 across the SPI physical medium 68, the directory and file manager 16 and the media player 18 are connected to an SPI driver 78 via connection lines 80 and 82 respectively. In turn, the SPI driver 78 is connected to the SPI physical medium 68 via a connection line 84. As in the preferred embodiment, control commands are sent to the data providing device 60 from the directory and file manager 16 and the media player 18 of PC 2, and data contents are returned from the data providing device 60 via the same route.

One of the types of memory contained on present memory cards, such as SD and MMC cards is a form of Non-Volatile Memory (NVM) known as NAND flash memory. Flash memory is non-volatile computer memory that can be electrically erased and reprogrammed. NAND flash memory is relatively unreliable and necessitates the use of error detection measures such as Cyclic Redundancy Check (CRC). In order for the alternative embodiment of the present invention to present data as if it is the contents of a NVM flash memory card, the physical connection and access protocols must be consistent with the specific type of memory card under emulation.

In the present alternative embodiment the data providing device 60 emulates an SD or MMC memory card. Accordingly, the physical interface between the PC 2 and the data providing device 60 is the SPI physical medium 68. During communication between the PC 2 and the data providing device 60, the processing unit 72 divides data content sent from the storage volume emulator 62 to the PC 2 into 512-byte data sectors. Before each data sector is sent, a 2-byte CRC is calculated by the processing unit 72 using the data sector and then the CRC is appended to the data sector. Once the CRC has been appended the data sector is sent over the SPI physical medium 68 to the PC 2.

The page mapping element 64 maps each data sector to a corresponding physical page that exists in the memory of data providing device 60. This process enables data sectors to be dynamically allocated so that data contained on the data providing device 60 can remain mobile around the memory of the data providing device 60 while, at the same time a fixed file structure is presented by the data providing device 60 to the PC 2.

A PC has been used above as a vehicle for explaining the preferred and alternative embodiments of the present invention. However, it should be understood that alternative host devices may be used without departing from the inventive concept of any embodiment. The key principle is that the host device contains a physical interface that corresponds with the physical interface of an embodiment of the present invention. Furthermore, the host device must also have an intrinsic software interface driver installed that enables it to interface with a removable storage device equivalent to one that the embodiment of the present invention emulates, such that no further software device drivers need be installed on the host device.

It is also within the scope of the present invention that the data providing device may also provide a cooperating host device with data which is not associated with a live broadcast. For example, it is also within the scope of the invention that the data providing device provides information such as, status information or diagnostic information. Additionally, the data providing device could provide auxiliary or optional control functionalities, such as, power-control settings.

Various modifications, including additions and deletions of features, will be apparent to the skilled person and which may be made to the above described embodiments to provide further embodiments of the present invention, any and all of which are intended to be encompassed within the scope of the appended claims.

1. A data providing device for providing data to a host device, the device comprising a data source which buffers dynamically changing data and outputs the data for provision to the host device, and a data interface which presents the data for provision to the host device as static contents within a removable storage device that is recognised by and communicates with the host device through at least one mass storage device driver that is installed on the host device.

2. A data providing device as claimed in claim 1 wherein the data source is capable of being instructed by the host device to select which dynamically changing data it buffers and outputs, from a plurality of sets of such data.

3. A data providing device as claimed in claim 1 wherein the data interface arranges the data for provision to the host device into files.

4. (canceled)

5. (canceled)

6. A data providing device as claimed in claim 1 wherein the data source is a receiver which, receives dynamically changing data broadcast to the receiver from an external device, buffers the received data and, outputs the received data for provision to the host device.

7. A data providing device as claimed in claim 6 wherein the receiver is triggered to receive data by commands received from the host device, and wherein the receiver is capable of receiving one or more broadcast signals from one or more external devices, the or each signal containing one or more broadcast services, and wherein the dynamically changing data includes at least one broadcast service specified by a command received from the host device.

8. (canceled)

9. A data providing device as claimed in claim 7 wherein the command specifies the at least one broadcast service by comprising a representation of the at least one broadcast service, wherein the representation comprises a representation of a broadcast frequency of the broadcast signal containing the at least one broadcast service and, a representation of the at least one broadcast service.

10. (canceled)

11. (canceled)

12. A data providing device as claimed in claim 7 wherein the data interface is capable of enabling:
i. delivery of data relating to commands specifying broadcast services, from the host device to the receiver;
ii. delivery of data relating to broadcast signals and broadcast services available to be received by the receiver, from the receiver to the host device; and,
iii. delivery of data relating to broadcast services specified by commands received from the host device, from the receiver to the host device.

13. (canceled)

14. (canceled)

15. A data providing device as claimed in claim 1 wherein the data providing device stores data for a finite period after it has presented that data to the host device, to facilitate a rewind capability.

16. A data providing device as claimed in claim 1 wherein the data providing device and the host device communicate with each other via at least one selected from the group comprising: a Universal Serial Bus (USB) interface, a Serial Peripheral Interface (SPI) bus, a Secure Data Memory Interface (SD) bus, an Integrated Drive Electronics (IDE) bus or a Small Computer System Interface (SCSI) bus.

17. (canceled)

18. (canceled)

19. (canceled)

20. (canceled)

21. A data providing device as claimed in claim 16 wherein the removable storage device is selected from the group comprising: a USB Mass Storage Device (MSD), a Multi-Media Card (MMC), a Secure Digital (SD) Card, a Compact Flash (CF) Card, or an SCSI hard disk.

22. (canceled)

23. (canceled)

24. (canceled)

25. (canceled)

26. (canceled)

27. (canceled)

28. (canceled)

29. (canceled)

30. A method for providing data from a data providing device to a host device the method comprising the following steps:
a. buffering dynamically changing data from a data source of the data providing device;
b. presenting the data to the host device as static content within a removable storage device using a data interface, wherein the removable storage device is of a type that is recognised by and communicates with the host device through at least one mass storage device driver that is installed on the host device; and
c. outputting the data for provision to the host device from the data source.

31. A method as claimed in claim 30 wherein an instruction is received by the data source from the host device which instructs the data source to select which dynamically changing data it buffers and outputs, from a plurality of sets of such data.

32. A method as claimed in claim 30 or claim 31 wherein, the data interface arranges the data for presenting to the host device into files.

33. (canceled)

34. (canceled)

35. A method as claimed in claim 30 wherein, the data source is a receiver and step a. comprises, wirelessly receiving dynamically changing data broadcast to the receiver from an external device and, buffering the received data from the receiver.

36. A method as claimed in claim 35 wherein, the receiver is triggered to receive data by commands received from the host device, wherein the receiver is capable of receiving one or more broadcast signals from one or more external devices, the or each signal containing one or more broadcast services, and wherein the dynamically changing data includes at least one broadcast service specified by the commands received from the host device.

37. (canceled)

38. A method as claimed in claim 36 wherein the command specifies the at least one broadcast service by comprising a representation of the at least one broadcast service, wherein the representation comprises a representation of a broadcast frequency of the broadcast signal containing the at least one broadcast service and a representation of the at least one broadcast service.

39. (canceled)

40. (canceled)

41. A method as claimed in claim 36 wherein the data interface enables the following steps:
i. delivery of data relating to commands specifying broadcast services, from the host device to the receiver;
ii. delivery of data relating to broadcast signals and broadcast services available to be received by the receiver, from the receiver to the host device; and,
iii. delivery of data relating to broadcast services specified by commands received from the host device, from the receiver to the host device.

42. (canceled)

43. (canceled)

44. A method as claimed in claim 30 further comprising, the step of storing data in the data providing device for a finite period after it has been presented to the host device, to facilitate a rewind capability.

45. A method as claimed in any of claims 30 to 44 wherein, the data providing device and the host device communicate with each other via one selected from the group comprising: a Universal Serial Bus (USB) interface, a Serial Peripheral Interface (SPI) bus, a Secure Data Memory Interface (SD) bus, an Integrated Drive Electronics (IDE) bus, or a Small Computer System Interface (SCSI) bus.

46. (canceled)

47. (canceled)

48. (canceled)

49. (canceled)

50. A method as claimed in claim 45 wherein, the removable storage device is a device selected from the croup comprising: a USB Mass Storage Device (MSD) MMC, a SD card, a CF card, or an SCSI hard disk.

51. (canceled)

52. (canceled)

53. (canceled)

54. (canceled)

55. (canceled)

56. (canceled)

57. (canceled)

58. (canceled)
